(19) United States
(12) Patent Application Publication
(10) Pub. No.: US 2023/0232061 A1
(43) Pub. Date: Jul. 20, 2023

(54) ELECTRONIC DEVICE, CONTROL METHOD, AND LIVE STREAMING SYSTEM

(71) Applicant: Beijing Bytedance Network Technology Co., Ltd., Beijing (CN)

(72) Inventors: Yingyi CHEN, Beijing (CN); Dangwei WEI, Beijing (CN); Chao ZENG, Beijing (CN)

(21) Appl. No.: 17/928,897

(22) PCT Filed: May 13, 2021
(86) PCT No.: PCT/CN2021/093605

§ 371 Date: Nov. 30, 2022

(30) Foreign Application Priority Data
Jul. 31, 2020 (CN) 202010759420.3

(51) Int. Cl. H04N 21/422; H04N 21/4223; H04N 21/2187

(52) U.S. Cl. CPC H04N 21/42222; H04N 21/42203; H04N 21/42224; H04N 21/4223; H04N 21/2187

(57) ABSTRACT

An electronic device includes a main control display apparatus, a photographing apparatus, an audio processing controller, a voice pickup apparatus, and a loudspeaker apparatus. The main control display apparatus includes a case, a touch display screen and a controller, the controller is arranged in the case, and the touch display screen is embedded in the case and electrically connected to the controller; the photographing apparatus is connected to the case and electrically connected to the controller; the audio processing controller is electrically connected to the controller; the voice pickup apparatus is arranged on the case and electrically connected to the controller; and the loudspeaker apparatus is arranged on the case and electrically connected to the audio processing controller.

This application claims the priority of Chinese Patent Application No. 202010759420.3, filed on Jul. 31, 2020, and the entire disclosure of which is incorporated here as a part of the present application by reference.

### TECHNICAL FIELD

Embodiments of the present disclosure relates to a technical field of smart terminals, in particular to an electronic device, a control method and a live streaming system.

### BACKGROUND

With the development of the mobile Internet technology and the smart terminal technology, the interactive method such as live streaming is favored by more and more users, and the interactive method of live streaming is more and more used in entertainment, teaching and other scenarios.

### SUMMARY

In a first aspect, an embodiment of the present disclosure provides an electronic device, which includes: a main control display apparatus, the main control display apparatus includes a case, a touch display screen and a controller, the controller is arranged in the case, and the touch display screen is arranged on the case and electrically connected to the controller; a photographing apparatus which is connected to the case and electrically connected to the controller; an audio processing controller which is electrically connected to the controller; a voice pickup apparatus which is arranged on the case and electrically connected to the controller; and a loudspeaker apparatus which is arranged on the case and electrically connected to the audio processing controller.

Alternatively, the electronic device further includes a supporting structure, the supporting structure is connected to the case and configured for supporting the main control display apparatus.

Alternatively, the supporting structure includes a housing, and the loudspeaker apparatus is arranged in an accommodation cavity of the case; and the housing is arranged on a side of the case away from the touch display screen, and the housing is away from a top of the case.

Alternatively, the supporting structure includes a bottom, the loudspeaker apparatus and the audio processing controller is integrated in the bottom, and the bottom is detachably connected to the case.

Alternatively, the bottom is arranged with an operation key and a plug port; both the operation key and the plug port are electrically connected to the main control display apparatus.

Alternatively, the case is further arranged with at least one knob, the knob is electrically connected to the controller, the voice pickup apparatus, the loudspeaker apparatus and the plug port, and is used for adjusting a volume of the voice pickup apparatus, a volume of the loudspeaker apparatus and/or a volume of an external device to which the plug port is electrically connected.

Alternatively, a voice pickup hole of the voice pickup apparatus is arranged between the touch display screen and the knob.

Alternatively, the bottom is arranged with a mounting connector, and the mounting connector is used for connecting with an adjusting support apparatus.

Alternatively, the photographing apparatus is arranged at a top of the case and rotatably connected to the case.

Alternatively, the electronic device further includes a lighting apparatus, the lighting apparatus is detachably connected to the case.

Alternatively, the case is arranged with a connector socket, the lighting apparatus is arranged with a connector plug which is matched with the connector socket, and the lighting apparatus and the controller are electrically connected through the connector socket and the connector plug.

Alternatively, the main control display apparatus is arranged with a light sensation sensor, the light sensation sensor is electrically connected to the controller, and the controller is configured to adjust a brightness of the touch display screen according to information transmitted by the light sensation sensor.

Alternatively, the electronic device further includes a speech recognition apparatus which is electrically connected to the voice pickup apparatus and the controller, respectively.

Alternatively, the controller is configured to adjust the brightness of the touch display screen according to a signal transmitted by the speech recognition apparatus.

Alternatively, the electronic device further includes a video image processing controller, the video image processing controller is electrically connected to the imaging device and the controller, respectively.

In a second aspect, an embodiment of the present disclosure provides a live streaming system, which includes the electronic device provided in the first aspect above and an adjusting support apparatus, the adjusting support apparatus is detachably connected to the electronic device.

In a third aspect, an embodiment of the present disclosure provides a control method of electronic device, which includes: receiving a control instruction and an audio data transmitted by a controller of a main control display apparatus, processing the audio data, and transmitting a processed audio data to a loudspeaker apparatus and/or the controller.

In a fourth aspect, an embodiment of the present disclosure provides a control method of electronic device, which includes:

receiving audio information to be processed, and sending a first turn-on instruction to an audio processing controller; and

decoding the audio information to be processed to generate audio data, and sending the audio data to the audio processing controller.

### BRIEF DESCRIPTION OF THE DRAWINGS

The above and/or additional aspects and advantages of the embodiments of the present disclosure will become apparent and easily understood from the following description of the embodiments with reference to the accompanying drawings, in which:

FIG. 1 is a structural schematic diagram of an electronic device provided by an embodiment of the present disclosure;

FIG. 2 is a partial enlarged view of part A of the electronic device provided in FIG. 1 according to the embodiment of the present disclosure;

FIG. 3 is a schematic diagram of an internal structure frame of an electronic device provided by the embodiment of the present disclosure.

### DETAILED DESCRIPTION OF REFERENCE SYMBOLS

10—Main control display apparatus; 20—Photographing apparatus; 30—Audio processing controller; 40—Voice pickup apparatus; 50—Speaker; 60—Bottom; 70—Lighting apparatus; 80—Light sensation sensor; 90—Speech recognition apparatus; 11—case; 12—Touch display screen; 13—controller; 41—Voice pickup hole of the voice pickup apparatus 40; 111—Knob.

### DETAILED DESCRIPTION

The present disclosure will be described in detail below. Examples of embodiments of the present disclosure are shown in the accompanying drawings, in which the same or similar reference numerals refer to the same or similar components or components with the same or similar functions throughout. In addition, if the detailed description of a known technology is unnecessary for the shown features of the present disclosure, it will be omitted. The embodiments described below with reference to the accompanying drawings are exemplary, and are only used to explain the present disclosure, and cannot be interpreted as a limitation of the present disclosure.

It can be understood by those skilled in the art that unless otherwise defined, all terms (including technical terms and scientific terms) used herein have the same meanings as those commonly understood by those skilled in the art to which the present disclosure belongs. It should also be understood that terms such as those defined in general dictionaries should be understood to have meanings consistent with those in the context of the prior art, and will not be interpreted with idealized or overly formal meanings unless specifically defined as here.

Those skilled in the art can understand that the singular forms “a”, “an” and “the” used here can also include plural forms unless specifically stated. It should be further understood that the terms, such as “include/comprising,” “include/including,” etc., used in the specification of the present disclosure refer to the presence of said features, integer, step, operation, element and/or component, but does not exclude the presence or addition of one or more other features, integers, steps, operations, elements, components and/or groups thereof. It should be understood that when we say that an element is “connected” or “coupled” to another element, it may be directly connected or coupled to the another element, or intervening element(s) may also exist. In addition, as used herein, “connected” or “coupled” may include wireless connection or wireless coupling. The expression “and/or” used here includes all or any unit and all combinations of one or more associated listed items.

At present, in order to ensure the effect of live streaming, users often need a computer, a mobile phone, a microphone, a sound card, a headset, a camera, a fill light and clamping brackets for fixing the above devices. At present, many hardware devices are needed for live streaming, and the devices are cumbersome, and the live streaming cost of users is relatively high; moreover, many wires are needed to connect the various devices. During live streaming, users often need to adjust each device separately, which is complicated in operation and brings inconvenience to users and reduces the live streaming experience of users. Further, during the use of the devices, devices are connected by plugging and wires, and repeated plugging is easy to damage a connector socket of the devices, thus reducing the service life of each device.

An embodiment of the present disclosure provides an electronic device, a control method and a live streaming system, with respect to the shortcomings of the current technology, so as to solve the technical problem that the operations are complicated in the live streaming process and inconvenience is brought to users in the current technology.

An embodiment of the present disclosure provides an electronic device including a main control display apparatus, a photographing apparatus, an audio processing controller, a voice pickup apparatus and a loudspeaker apparatus. The main control display apparatus includes a case, a touch display screen and a controller, the controller is arranged in the case, and the touch display screen is embedded on the case and electrically connected to the controller; a photographing apparatus is connected to the case and electrically connected to the controller; an audio processing controller is electrically connected to the controller; a voice pickup apparatus is arranged on the case and electrically connected to the controller; and a loudspeaker apparatus is arranged on the case and electrically connected to the audio processing controller.

The electronic device provided by an embodiment of the present disclosure integrates the main control display apparatus, the photographing apparatus, the audio processing controller, the voice pickup apparatus and the loudspeaker apparatus into a whole, thus avoiding the inconvenience caused to users by connecting each device through wires; by controlling the main control display apparatus, the user can control each device connected to the main control display apparatus, which is convenient for the user and improves the user experience. Meanwhile, the electronic device provided by the embodiment of the present disclosure is separately provided with the audio processing controller configured for processing audio information, which reduces the load of the main control display apparatus and facilitates users to select different audio processing controllers according to different needs.

Additional aspects and advantages of the disclosure will be set forth in part in the following description, and these will be obvious from the following description, or may be learned by practice of the disclosure.

The technical scheme of the present disclosure and how the technical scheme of the present disclosure solves the above technical problems will be explained in detail with the specific examples below.

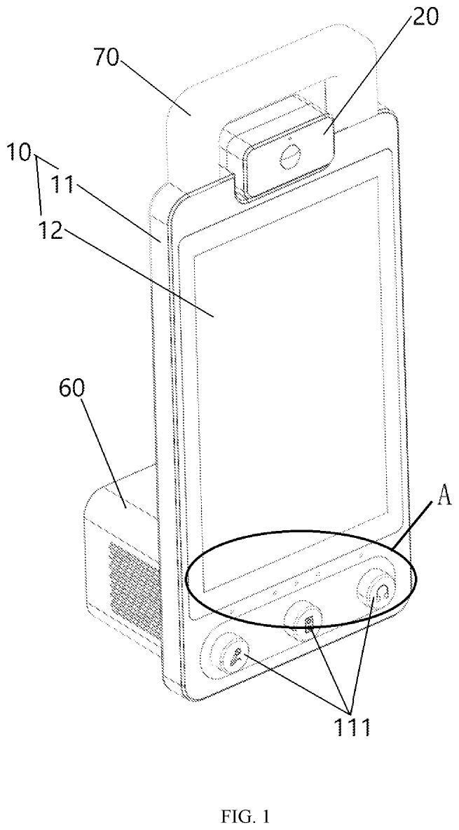

An embodiment of the present disclosure provides an electronic device, as shown in FIG. 1 and FIG. 3, which are the structural schematic diagrams of the electronic device and the internal structural frame schematic diagram of the electronic device, respectively. The electronic device can be used for network live streaming, online teaching live streaming, online conference, etc. The electronic device includes: a main control display apparatus 10, which includes a case 11, a touch display screen 12 and a controller 13, with the controller being arranged in the case 11 and the touch display screen 12 being arranged on the case 11 and electrically connected to the controller 13; a photographing apparatus 20 connected to the case 11 and electrically connected to the controller 13; an audio processing controller 30 electrically connected to the controller 13; a voice pickup apparatus 40 arranged on the case 11 and electrically connected to the controller 13; and a speaker 50 arranged on the case 11 and electrically connected to the audio processing controller 30.

The electronic device provided by an embodiment of the present disclosure integrates the main control display apparatus, the photographing apparatus, the audio processing controller, the voice pickup apparatus and the loudspeaker apparatus into a whole, thus avoiding the inconvenience caused to users by connecting each device through wires; by controlling the main control display apparatus, the user can control each device connected to the main control display apparatus, which is convenient for the user and improves the user experience. Furthermore, the electronic device provided by the embodiment of the present disclosure is separately provided with the audio processing controller for processing audio information, which reduces the load of the main control display apparatus and facilitates users to select different audio processing controllers according to different needs.

Specifically, in the electronic device provided by an embodiment of the present disclosure, the main control display apparatus 10, the photographing apparatus 20, the audio processing controller 30, the voice pickup apparatus and the loudspeaker apparatus 50 are integrated into a whole. By integrating the main control display apparatus 10, the photographing apparatus 20, the audio processing controller 30, the voice pickup apparatus 40 and the loudspeaker apparatus 50 into a whole, the problem of poor compatibility among various components of an existing distributed live streaming device is solved, and the stability of the electronic devices are improved; moreover, the configuration avoids potential safety risks and inconvenience caused by the connection between various devices through wires.

In the electronic device provided by an embodiment of the present disclosure, the main control display apparatus 10 includes a case 11, a touch display screen 12 and a controller 13, the controller is arranged in the case 11, and the touch display screen 12 is arranged on the case 11 and electrically connected to the controller 13. As shown in FIG. 1, the periphery of the touch display screen 12 is covered by the case 11. The touch display screen 12 is used to realize the information interaction function between a user and the electronic device. The user can control the display content of the touch display screen 12 through the touch display screen 12, and can also control various devices electrically connected to the controller 13 of the main control display apparatus 10 through the touch display screen 12.

The photographing apparatus 20, the voice pickup apparatus 40 and the loudspeaker apparatus 50 are all arranged on the case 11, the photographing apparatus 20, the audio processing controller 30 and the voice pickup apparatus 40 are all electrically connected to the controller 13 of the main control display apparatus 10, and the loudspeaker apparatus 50 is electrically connected to the audio processing controller 30. The electronic device provided in the embodiment of the present disclosure is provided with the audio processing controller 30 independent of the controller 13. The audio processing controller 30 is used to process decoded audio data information transmitted by the voice pickup apparatus and the controller 13, process the decoded audio data information by the processing methods of beautifying, mixing, tuning, etc., and send the processed audio data information to the loudspeaker apparatus 50 for playing. The audio processing controller 30 can also directly receive and process audio data information transmitted by external apparatuses such as microphone, mobile phone, computer, etc., and after processing the audio data information by the processing methods of beautifying, mixing, tuning, etc., send the processed audio data information to external playing devices such as headphone and speaker for playing.

The electronic device provided by an embodiment of the present disclosure is configured to separates the audio processing controller 30 for processing audio data information from the controller 13, reduces the computation load of the controller 13 and the coupling between the audio processing controller 30 and the controller 13 of the main control display apparatus 10. Moreover, a user can select an appropriate audio processing controller 30 according to his/her own needs, which can prevent the user from frequently changing electronic devices due to the audio processing capability of electronic devices being unable to meet the users' needs, thus reducing the user's use cost and prolonging the service life of the electronic devices.

In the electronic device provided by the embodiment of the present disclosure, the controller 13 can be a CPU (Central Processing Unit), a general-purpose processor, a DSP (Digital Signal Processor), an ASIC (Application Specific Integrated Circuit), an FPGA (Field-Programmable Gate Array) or another programmable logic device, a transistor logic device, a hardware device or any combination thereof. It can implement or execute various exemplary devices described in connection with the present disclosure.

In an embodiment provided by the present disclosure, the electronic device further includes a supporting structure, the supporting structure is connected to the case 11 and configured for supporting the main control display apparatus 10. With the supporting structure connected to the case 11 of the main control display apparatus 10 being provided, the supporting structure of the electronic device can be used to support the electronic device without supporting the electronic device by means of an external support mechanism, which is convenient for users to use.

Alternatively, in an embodiment of the present disclosure, the supporting structure includes a housing, and the loudspeaker apparatus 50 is arranged in an accommodation cavity of the housing, the housing is arranged on a side of the case 11 away from the touch display screen 12, and the housing is away from a top of the case 11. It can be noted that, in order to improve the sound effect of the audio played by the electronic device, the loudspeaker apparatus 50 is usually relatively big in volume, and in order to facilitate the maintenance and replacement of the loudspeaker apparatus 50, the loudspeaker apparatus 50 is often set independently of the main control display apparatus 10. Therefore, in an embodiment of the present disclosure, the loudspeaker apparatus 50 is arranged in the accommodation cavity of the housing of the supporting structure, and the supporting structure is combined with the loudspeaker apparatus, so that the volume of electronic device is reduced, and the housing can also functions in protecting the loudspeaker apparatus 50.

The housing is arranged on a side of the case 11 away from the touch display screen 12, which avoids the interference of the housing on the user's operation of the touch display screen 12. Meanwhile, the loudspeaker apparatus 50 arranged inside the housing can provide background music, voice playing and other functions for the electronic device, and the user can operate and control the loudspeaker apparatus 50 by touching the touch display screen 12. In an embodiment of the present disclosure, with providing the loudspeaker apparatus 50, the situation that users need to use an external speaker, a smart phone or other speaker device to provide background music in the live streaming process by using a current live streaming device is avoided, and the operation and use of the user is facilitated.

In order to further ensure the supporting effect of the housing with respect to the main control display apparatus 10, the housing is set away from the top of the case 11 and has a certain distance from the bottom of the case 11. Thus, when the electronic device is placed on a placement surface, both the bottom of the case 11 and the housing can contact the placement surface, and the housing plays a role in supporting the main control display apparatus 10, thus improving the stability of the electronic device on the placement surface without an external support mechanism supporting the electronic device. Furthermore, in the embodiment of the present disclosure, in order to ensure that the housing can effectively support the main control display apparatus 10 and improve the stability of the electronic device on the placement surface, it is necessary to ensure that an angle between the main control display apparatus 10 and the horizontal plane of the placement surface is greater than 90° when the electronic device is placed on the horizontal placement surface. In this way, while the housing can effectively support the main control display apparatus 10, the angle between the touch display screen 12 of the main control display apparatus 10 and the placement surface can be greater than 90, so that the touch display screen 12 can face the face of the user, and the comfort of the user in using electronic device is improved. Meanwhile, the bottom of the housing and the case 11 which both contact with the placement surface are also provided with anti-slip silica pads, which further ensure the stability of the electronic device.

It should be noted that the top of the case 11 here specifically refers to the end of the case 11 close to the photographing apparatus 20. In the process of live streaming by use of the electronic device, in general, the end of the case 11 away from the photographing apparatus 20 is in contact with the placement surface, so the end of the case 11 close to the photographing apparatus 20 is defined as the bottom of the case 11.

In one embodiment of the present disclosure, the supporting structure includes a back shell 60, the loudspeaker apparatus 50 and the audio processing controller 30 are integrated into the back shell 60, and the back shell 60 is detachably connected to the case 11.

Specifically, as shown in FIG. 1, in an embodiment of the present disclosure, the back shell 60 is arranged on a back side of the case 11, that is, on a side of the case 11 away from the touch display screen 12, and the loudspeaker apparatus 50 and the audio processing controller 30 are integrated into the back shell 60, and the back shell 60 is detachably connected to the case 11. For example, the back shell 60 can be detachably connected to the case 11 by the means of a snap or screw connection. This arrangement has the advantages that when the loudspeaker apparatus 50 or the audio processing controller 30 needs to be replaced, only the back shell 60 needs to be disassembled, thus avoiding disassembling the main control display apparatus 10 of the electronic device. In an embodiment of the present disclosure, since the loudspeaker apparatus 50 and the audio processing controller 30 are integrated in the back shell 60, the back shell 60 supports the main control display apparatus 10 so that the angle between the main control display apparatus 10 and the horizontal plane is rendered greater than 90°.

Furthermore, in an embodiment of the present disclosure, the integration of the audio processing controller 30 and the controller 13 is avoided, thereby increasing the heat dissipation space for the main control display apparatus 10. When the electronic device is working, both the main control display apparatus 10 and the audio processing controller 30 release a large amount of heat. By arranging the audio processing controller 30 on the back of the case 11 of the main control display apparatus 10, the mutual influence of the heat released by the main control display apparatus 10 and the audio processing controller 30 is avoided, the heat dissipation rate of both the main control display apparatus 10 and the audio processing controller 30 is improved, the influence of high temperature on the internal electrical components of the electronic device is slowed down, and the service life of the electronic device is prolonged. Further, the audio processing controller 30 shares part of the computing processing tasks of the controller 13 of the main control display device 10, and reduces the computation load of the controller 13, thus reducing the heat generation of the controller 13 during the operation of the electronic device.

It should be noted that the supporting structure includes two kinds of structures: the housing and the back shell 60. Because the difference between the two structures lies only in that their internal components that are accommodated and mounted inside each of them are different and the their ways of connection with the case 11 are different, and in the drawings of an embodiment of the present disclosure, only the back shell 60 is used to illustrate how the supporting structure can support the main control display apparatus 10.

In an embodiment of the present disclosure, the back shell 60 is provided with an operation key and a plug port. The operation key and the plug port are electrically connected to the main control display apparatus 10, the operation key is used to control the on-off state of the live streaming device, and the plug port is used to connect a network cable and/or an external apparatus.

In an embodiment of the present disclosure, the operation key and the plug port are arranged on the back shell 60, and the operation key are electrically connected to the main control display apparatus 10, so that the on-off state of the electronic device can be controlled by the operation key. The plug port is electrically connected to the main control display apparatus 10, and is used for connecting a network cable and/or an external apparatus. In an embodiment of the present disclosure, the external apparatus includes but are not limited to a headphone, a microphone, a power supply or other device, and the plug port includes a USB interface, a Type-C interface, an RJ45 network interface, a card slot used for plugging a mobile phone card or the like. By reserving various types of interfaces, the use needs of different users can be met. By connecting different devices, users can enrich the functions of the electronic device, thus improving the user's experience and the practicability of the electronic device. The wall of the back shell 60 is also provided with a plurality of through holes, which have the functions of heat dissipation and sound transmission for the loudspeaker apparatus 50.

By arranging the operation key and the plug port on the back shell 60, the problem of an area of the touch the display screen 12 of the main control display apparatus 10 being reduced due to the situation where the operation key and the plug port are arranged on the main control display apparatus 10 is avoided. Moreover, the operation key and the plug port are arranged on the back of the electronic device, which reduces the risk of false touch during the live streaming of a user.

In an embodiment of the present disclosure, the case 11 is further provided with at least one knob 111. The knob 111 is electrically connected to the controller 13, the voice pickup apparatus 40, the loudspeaker apparatus 50 and the plug port, and is used for adjusting the volume of the voice pickup apparatus 40, the loudspeaker apparatus 50 and/or the external apparatus. In an embodiment of the present disclosure, three knobs 111 are arranged in a straight line, which are respectively used to adjust the volume of the voice pickup apparatus 40, the loudspeaker apparatus 50, and the external apparatus.

In an embodiment of the present disclosure, the volume of the voice pickup apparatus, the loudspeaker apparatus 50 and/or the external apparatus can be adjusted by three knobs 111. During the live streaming, the knobs 111 are convenient for the user to adjust the volume of the voice pickup apparatus, the loudspeaker apparatus 50 and the external apparatus in time. As an example, a touch button, a physical key, etc. can also be used to adjust and control the volume of the voice pickup apparatus, the loudspeaker apparatus 50 and the external apparatus.

In one embodiment of the present disclosure, the voice pickup hole(s) 40 of the voice pickup apparatus is disposed between the touch display screen 12 and the knobs 111. The voice pickup holes 40 of the voice pickup apparatus are used to collect the user's voice and the environment sound, and transmit the collected sound information to the voice pickup apparatus, and then to the audio processing controller 30. The audio processing controller 30 processes the received sound information and sends the processed sound information to the loudspeaker apparatus 50 for playing. Alternatively, the audio processing controller 30 converts the audio data information into corresponding control instructions and sends the control instructions to the controller 13.

In one embodiment of the present disclosure, the back shell 60 is provided with a mounting connector, and the mounting connector is used for connecting with an adjusting support apparatus. In an embodiment of the present disclosure, the mounting connector includes a clamping slot, and the adjusting support apparatus includes a tripod, a support frame, or the like, and is detachably connected to the adjusting support apparatus such as the tripod, the support frame, or the like through the clamping slot, so that the height of the electronic device can be adjusted upwards or downwards and the angle of the electronic device can be adjusted, the use needs of different users are met, the operation experience of users is improved, the application scenarios of the electronic device are expanded, and the use of the electronic device is convenient for users.

In one embodiment of the present disclosure, the photographing apparatus 20 is arranged at the top of the case 11 and rotatably connected to the case 11 through a rotating axis. As shown in FIG. 1, the top of the case 11 is provided with a groove for accommodating the photographing apparatus 20, the rotating axis is arranged at both sides of the photographing apparatus 20, and the photographing apparatus 20 can rotate around the rotating axis. The side walls of both ends of the groove are provided with mounting holes matched with the rotating axis, and the rotating axis is mounted in the mounting holes, thus realizing the connection between the photographing apparatus 20 and the case 11. The photographing apparatus 20 and the case 11 can be detachably connected, so that the user can replace the photographing apparatus 20.

It should be noted that, in order to improve the intelligence level of electronic device, the live streaming device can optionally be provided with a linear motor or a rotor motor, and the motor drives the rotating axis to rotate, and the motor is electrically connected to the controller 13, so that the rotation of the photographing apparatus 20 can be controlled by the touch on the touch display screen 12 or voice control.

In one embodiment of the present disclosure, the electronic device further includes a lighting apparatus 70, which is detachably connected to the case 11. The lighting apparatus 70 can provide enough light for the photographing apparatus 20 to ensure the imaging quality of live streaming pictures during the live streaming. The lighting apparatus 70 is detachably connected to the case 11, so that it is convenient for the user to select among the lighting apparatuses with different emitting colors, and the choices of user are enriched. In an embodiment of the present disclosure, the lighting apparatus 70 includes an LED light bar, which has the advantages of high brightness and low power consumption.

Furthermore, the case 11 is provided with a connector socket, and the lighting apparatus 70 is provided with a connector plug matched with the connector socket. When the connector plug is plugged into the connector socket, the lighting apparatus 70 is electrically connected to the controller 13. The connector socket can be set as a conventional USB interface, a Type-C interface, etc. In this way, when the user does not need the lighting apparatus 70, power supply, data transmission, external intelligent terminal devices, etc. can be provided through the connector socket, thus expanding the application scenarios of the connector socket.

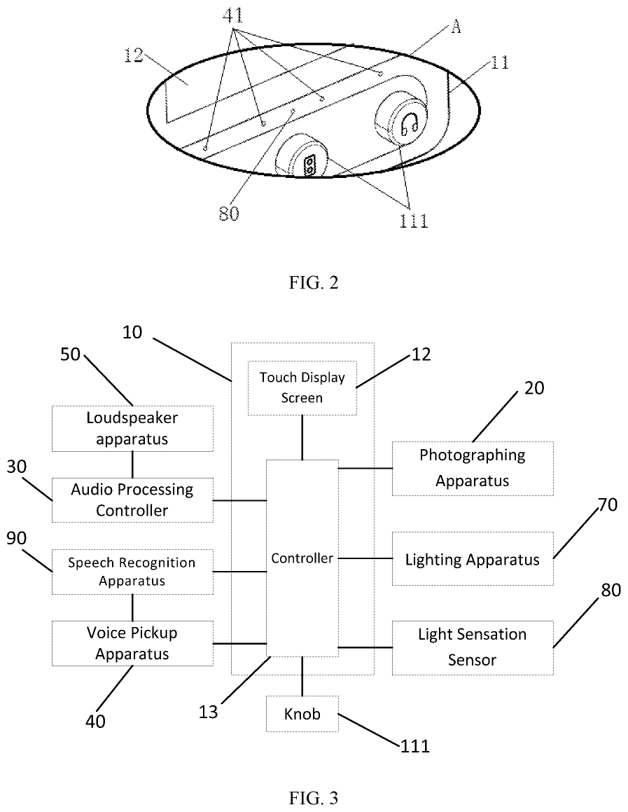

In an embodiment of the present disclosure, as shown in FIG. 2, the main control display apparatus 10 is provided with a light sensation sensor 80, which is electrically connected to the controller 13, and the controller 13 controls the brightness of the touch display screen 12 according to the information transmitted by the light sensation sensor 80. In an embodiment of the present disclosure, the light sensation sensor 80 is arranged between the voice pickup holes of the voice pickup apparatus 40, and is located in the middle part of the lower part of the main control display apparatus 10, so that the light sensation sensor 80 can more accurately collect the light brightness of the environment where the live streaming device is located.

With the provision of the light sensation sensor 80, the light sensation sensor 80 can automatically adjust the screen brightness of the touch display screen 12 according to the light brightness of the current environment of the electronic device, thus bringing the best visual effect to the user. For example, in a dark environment, the screen backlight of the touch display screen 12 of the live streaming device is controlled to darken, so as to avoid stimulating the eyes of the user and causing discomfort to the user. Meanwhile, by automatically adjusting the screen brightness of the touch display screen 12, the purpose of saving energy and electricity can be achieved, and unnecessary waste of electric energy can be avoided. As an example, the user can also send a brightness control signal to the controller 13 through a speech recognition apparatus, so as to realize the voice control of the brightness of the touch display screen 12.

In an embodiment of the present disclosure, the electronic device further includes a speech recognition apparatus 90, which is electrically connected to the voice pickup apparatus 40 and the controller 13, respectively. The user's voice is collected through the voice pickup holes 41 of the voice pickup apparatus 40, and the collected voice information is transmitted to the voice pickup apparatus 40, and then to the speech recognition apparatus 90. The speech recognition apparatus 90 processes the received voice information, extracts the instruction information from the voice information, and sends the instruction information to the controller 13, thus realizing the function of the voice control of electronic device. For example, the speech recognition apparatus 90 can realize the function of controlling the volume of electronic device by voice, thus avoiding setting volume adjustment buttons such as the knob 111, a touch button or a physical button, and simplifying the appearance structure of electronic device. In an embodiment of the present disclosure, the controller 13 controls the brightness of the touch display screen 12 according to the signal transmitted by the speech recognition apparatus 90, for example, the brightness control signal. Through the speech recognition apparatus, the brightness of the touch display screen 12 can be adjusted by voice, which is convenient for user.

It should be noted that the electronic device may also include a memory used for storing data. The memory can be electrically connected to the controller 13 through a plug port. The memory can be ROM (Read-Only Memory) or other types of static storage devices that can store static information and instructions, RAM (random access memory) or other types of dynamic storage devices that can store information and instructions, EEPROM (Electrically Erasable Programmable Read Only Memory), CD-ROM (Compact Disc Read-Only Memory) or other optical storage, optical storage (including compact disc, laser disc, optical disc, digital versatile disc, Blu-ray disc, etc.), magnetic storage media or other magnetic storage devices, or any other media that can be used to carry or store desired program codes in the form of instructions or data structures and can be accessed by a computer, but it is not limited to the above.

The electronic device may also include a communication device, which can facilitate the user to operate and control the electronic device through a remote device.

In an embodiment of the present disclosure, the electronic device may further include a video image processing controller, which is electrically connected to the photographing apparatus 20 and the controller 13, respectively. The video image processing controller is used to process the video image data information transmitted by the photographing apparatus 20 and the controller 13, process the video image data information through modulation and demodulation, and send the processed video image data information to the touch display screen 12 for playing.

The electronic device provided by an embodiment of the present disclosure further reduces the operation load of the controller 13 by separately setting the video image processing controller for processing the video image data information. Meanwhile, the user can select an appropriate video image processing controller according to his/her own needs, to avoid the frequent replacement of electronic devices because the video image processing capability of electronic devices can't meet the user's needs, thus reducing the user's use cost and prolonging the service life of the electronic device.

According to a concept of the present disclosure, an embodiment of the present disclosure provides a live streaming system, which includes the electronic device provided by any of the above embodiments and the adjusting support apparatus, and the adjusting support apparatus is detachably connected to the electronic device. Specifically, the adjusting support apparatus is detachably connected to a mounting base provided on the back shell 60 of the electronic device.

The height of the electronic device can be adjusted upwards or downwards and the angle of the electronic device can be adjusted by the adjusting support apparatus, so as to meet the needs of different users and improve the use experience of users. The adjusting support apparatus includes a telescopic tripod, a mounting column matched with the mounting base, and an angle adjusting mechanism arranged between the mounting column and the telescopic tripod. The height of the electronic device can be adjusted upwards and downwards through the telescopic tripod, and the rotation angle of the electronic device in the same plane can be adjusted through the angle adjusting mechanism, thereby adjusting the positional relationship between the electronic device and a user.

According to a concept of the present disclosure, an embodiment of the present disclosure provides a control method of electronic device, the method includes:

receiving a control instruction and audio data transmitted by the controller of the main control display apparatus, processing the audio data, and transmitting the processed audio data to the loudspeaker apparatus and/or controller.

Alternatively, the audio processing controller 30 receives a control instruction and audio data transmitted by the controller 13 of the main control display apparatus 10, processes the audio data, and transmits the processed audio data to the loudspeaker apparatus 50 and/or the controller 13. Specifically, the audio processing controller 30 receives the control instruction transmitted by the controller 13 of the main control display apparatus 10, and the control instruction may be a start instruction. Then, the audio processing controller 30 enters a working state, receives and processes the audio data transmitted by the controller 13, and after processing by beautifying, mixing, tuning, etc., transmits the processed audio data to the loudspeaker apparatus 50 for playing. When the processed audio data needs to be uploaded to a cloud server, the audio processing controller 30 also transmits the processed audio data to the controller 13 and uploads it to the cloud server through the controller 13. In an embodiment of the present disclosure, the controller 13 of the main control display apparatus 10 is used to decode the audio data and send the decoded audio data to the audio processing controller 30, which greatly reduces an operation load of the controller 13, thus improving an operation fluency of the electronic device.

It should be noted that the audio processing controller 30 can also directly receive and process the audio data information transmitted by an external apparatus such as microphone, mobile phone, computer, or the like, after processing audio data information by beautifying, mixing, tuning, etc., the processed audio data information will be sent to an external playing device such as headphone or speaker for playing.

It should be further noted that, when the audio processing controller 30 needs to be upgraded online, the controller 13 receives an upgrade installation package and sends an upgrade instruction and the upgrade installation package to the audio processing controller 30, thus completing the upgrade operation of the audio processing controller 30.

According to a concept of the present disclosure, an embodiment of the present disclosure provides a control method of an electronic device, the method includes:

Receiving audio information to be processed, and sending a first turn-on instruction to an audio processing controller; and

Decoding the audio information to be processed to generate audio data, and send the audio data to the audio processing controller.

Alternatively, the controller 13 of the main control display apparatus 10 receives the audio information to be processed, and sends a first turn-on instruction to the audio processing controller 30. The controller 13 decodes audio information to be processed to generate audio data, and sends the audio data to the audio processing controller 30. Specifically, when the controller 13 receives the audio information to be processed, it sends a first turn-on instruction to the audio processing controller 30, so that the audio processing controller 30 enters a working state. Then, the controller 13 decodes the audio information to be processed to generate audio data, and sends the audio data to the audio processing controller 30.

When the loudspeaker apparatus 50 of the electronic device is turned off, the controller 13 of the main control display apparatus 10 receives the audio information to be processed, and when sending the first turn-on instruction to the audio processing controller 30, sends a second turn-on instruction to the loudspeaker apparatus 50, so that the loudspeaker apparatus 50 is turned on and enters a working state, so that the audio data processed by the audio processing controller 30 can be played through the loudspeaker apparatus 50.

It should be noted that a user can transmit instruction information to the controller 13 of the main control display apparatus 10 by the touch display screen 12, the voice pickup apparatus 40, or the like, and the controller 13 can control the operation of the audio processing controller 30 to turn-on, turn-off and upgrade and control the operation of the loudspeaker apparatus 50 electrically connected to the audio processing controller 30 to turn-on, turn-off and upgrade according to the instruction information. For example, the controller 13 can receive the audio processing instruction input by the user by the touch display screen 12, the voice pickup apparatus 40, or the like. While receiving the audio processing instruction, the controller 13 receives the audio information to be processed, and perform decode operation on the audio information to be processed. The controller 13 sends the first turn-on instruction to the audio processing controller 30, so that the audio processing controller 30 enters a working state, and sends the audio data generated after decoding the audio information to be processed to the audio processing controller 30, so that the audio processing controller 30 processes the audio data by beautifying, mixing, tuning and other processing methods.

Alternatively, when the controller 13 detects that the audio processing controller 30 transmits the processed audio data to the loudspeaker apparatus 50 and/or the controller 13, the controller 13 generates a turn-off instruction and sends the turn-off instruction to the audio processing controller 30, so that the audio processing controller 30 turns off according to the turn-off instruction and enters a low power consumption mode, thereby reducing the power consumption of the electronic device.

It should be noted that, in the electronic device, the transmission protocol of audio information between the controller 13 of the main control display apparatus 10 and the audio processing controller 30 is IIC (Inter-Integrated Circuit) protocol, and the transmission protocol of instruction information is USB (Universal Serial Bus) protocol.

In applying the embodiments of the present disclosure, at least the following benefits can be achieved:

1. The live streaming device provided by an embodiment of the present disclosure integrates the main control display apparatus, the photographing apparatus, the audio processing controller, the voice pickup apparatus and the loudspeaker apparatus into a whole, thus avoiding the inconvenience caused to users by connecting various devices through wires; by controlling the main control display apparatus, a user can control devices connected to the main control display apparatus, which is convenient for the user and improves the user's experience. Meanwhile, the live streaming device provided by the embodiment of the present disclosure is separately provided with an audio processing controller configured for processing audio information, which reduces the load of the main control display apparatus and facilitates users to select different audio processing controllers according to different needs.

2. The audio processing controller 30 is arranged at the back side of the main control display apparatus 10, which avoids the integration of the audio processing controller 30 and the controller 13, increases the heat dissipation space of the main control display apparatus 10, avoids the mutual influence of heat released by the main control display apparatus 10 and the audio processing controller 30, improves the heat dissipation rate of the main control display apparatus 10 and the audio processing controller 30, slows down the influence of high temperature on the internal electrical components of the live streaming device, and prolongs the service life of the live streaming device.

Those skilled in the art can understand that the steps, measures and schemes in various operations, methods and processes already discussed in the present disclosure can be alternated, changed, combined or deleted. Further, other steps, measures and schemes in various operations, methods and processes already discussed in the present disclosure can also be alternated, changed, rearranged, decomposed, combined or deleted. Further, the steps, measures and schemes in the prior art with various operations, methods and processes disclosed in the present disclosure can also be alternated, changed, rearranged, decomposed, combined or deleted.

In the description of the present disclosure, it is understood that the terms “center”, “top”, “bottom”, “front”, “back”, “left”, “right”, “vertical”, “horizontal”, “top”, “bottom”, “inside”, “outside”, etc. indicate an orientation or positional relationship based on an orientation or positional relationship shown in the accompanying drawings and are intended only to facilitate and simplify the description of the present disclosure, not to indicate or imply that a device or element referred to must have a particular orientation or be constructed and operated in a particular orientation, and therefore are not to be construed as limiting the present disclosure.

The terms “first” and “second” are only used for descriptive purposes, and cannot be understood as indicating or implying relative importance or implicitly indicating a number of technical features indicated. Therefore, a feature defined as “first” and “second” may include one or more of these features explicitly or implicitly. In the description of the present disclosure, unless otherwise stated, “a plurality of” means two or more.

In the description of the present disclosure, it should be noted that unless otherwise specified and limited, the terms “mount”, “connect” and “couple” should be understood broadly, for example, they can be fixed connection, detachable connection or integrated connection, it can be directly connected or indirectly connected through an intermediate medium, or it can be the internal communication of two elements. For those of ordinary skill in the art, the specific meanings of the above terms in the present disclosure can be understood on a case-by-case basis.

In the description of this specification, the specific features, structures, materials or characteristics may be combined in any one or more embodiments or examples in a suitable way.

The above are only some embodiments of the present disclosure, and it should be pointed out that for those of ordinary skill in the technical field, without departing from the principles of the present disclosure, several improvements and embellishments can be made, and these improvements and embellishments should also be regarded as a scope of protection of the present disclosure.

1. An electronic device, comprising:
a main control display apparatus, wherein the main control display apparatus comprises a case, a touch display screen and a controller, the controller is arranged in the case, and the touch display screen is arranged on the case and electrically connected to the controller;
a photographing apparatus which is connected to the case and electrically connected to the controller;
an audio processing controller which is electrically connected to the controller;
a voice pickup apparatus which is arranged on the case and electrically connected to the controller; and
a loudspeaker apparatus which is arranged on the case and electrically connected to the audio processing controller.

2. The electronic device according to claim 1, further comprising a supporting structure, wherein the supporting structure is connected to the case and configured for supporting the main control display apparatus.

3. The electronic device according to claim 2, wherein the supporting structure comprises an housing, and the loudspeaker apparatus is arranged in an accommodation cavity of the case; and
the housing is arranged on a side of the case away from the touch display screen, and the housing is away from a top of the case.

4. The electronic device according to claim 2, wherein the supporting structure comprises a bottom, the loudspeaker apparatus and the audio processing controller is integrated in the bottom, and the bottom is detachably connected to the case.

5. The electronic device according to claim 4, wherein the bottom is arranged with an operation key and a plug port;
both the operation key and the plug port are electrically connected to the main control display apparatus.

6. The electronic device according to claim 5, wherein the case is further arranged with at least one knob, the knob is electrically connected to the controller, the voice pickup apparatus, the loudspeaker apparatus and the plug port, and is used for adjusting a volume of the voice pickup apparatus, a volume of the loudspeaker apparatus and/or a volume of an external device to which the plug port is electrically connected.

7. The electronic device according to claim 6, wherein a voice pickup hole of the voice pickup apparatus is arranged between the touch display screen and the knob.

8. The electronic device according to claim 4, wherein the bottom is arranged with a mounting connector, and the mounting connector is used for connecting with an adjusting support apparatus.

9. The electronic device according to claim 8, wherein the photographing apparatus is arranged at a top of the case and rotatably connected to the case.

10. The electronic device according to claim 1, further comprising a lighting apparatus, wherein the lighting apparatus is detachably connected to the case.

11. The electronic device according to claim 10, wherein the case is arranged with a connector socket, the lighting apparatus is arranged with a connector plug which is matched with the connector socket, and the lighting apparatus and the controller are electrically connected through the connector socket and the connector plug.

12. The electronic device according to claim 1, wherein the main control display apparatus is arranged with a light sensation sensor, the light sensation sensor is electrically connected to the controller, and the controller is configured to adjust a brightness of the touch display screen according to information transmitted by the light sensation sensor.

13. The electronic device according to claim 1, further comprising a speech recognition apparatus which is electrically connected to the voice pickup apparatus and the controller, respectively.

14. The electronic device according to claim 13, wherein the controller is configured to adjust the brightness of the touch display screen according to a signal transmitted by the speech recognition apparatus.

15. The electronic device according to claim 1, further comprising a video image processing controller, wherein the video image processing controller is electrically connected to the imaging device and the controller, respectively.

16. A live streaming system, comprising the electronic device according to claim 1 and an adjusting support apparatus, wherein the adjusting support apparatus is detachably connected to the electronic device.

17. A control method of electronic device, comprising:
receiving a control instruction and an audio data transmitted by a controller of a main control display apparatus,
processing the audio data, and
transmitting a processed audio data to a loudspeaker apparatus and/or the controller.

18. A control method of electronic device, comprising:
receiving audio information to be processed, and sending a first turn-on instruction to an audio processing controller; and
decoding the audio information to be processed to generate audio data, and sending the audio data to the audio processing controller.

19. The electronic device according to claim 3, wherein the supporting structure comprises a bottom, the loudspeaker apparatus and the audio processing controller is integrated in the bottom, and the bottom is detachably connected to the case.

20. The electronic device according to claim 2, further comprising a video image processing controller, wherein the video image processing controller is electrically connected to the imaging device and the controller, respectively.
